(19) United States
(12) Patent Application Publication
(10) Pub. No.: US 2015/0370226 A1
(43) Pub. Date: Dec. 24, 2015

(54) ELECTRONIC APPARATUS AND METHOD OF MANAGING FUNCTION IN ELECTRONIC APPARATUS

(71) Applicants: Samsung Electronics Co., Ltd., Gyeonggi-do (KR); Industry-Academic Cooperation Foundation, Yonsei University, Seoul (KR)

(72) Inventors: Sang-Ho KIM, Gyeonggi-do (KR); Sung-Bae CHO, Seoul (KR)

(73) Assignees: Samsung Electronics Co., Ltd.; Industry-Academic Cooperation Foundation, Yonsei University

(21) Appl. No.: 14/744,956

(22) Filed: Jun. 19, 2015

(30) Foreign Application Priority Data
Jun. 19, 2014 (KR) 10-2014-0075111

(51) Int. Cl. G05B 13/02; G06N 7/00; G06N 5/04

(52) U.S. Cl. CPC G05B 13/0205; G06N 5/04; G06N 7/005

(57) ABSTRACT

Disclosed are an electronic apparatus and function management method in the electronic apparatus. The electronic apparatus includes a sensor unit that includes at least one sensor and outputs sensor data by each of the at least one sensor, and a controller that infers a user's situation by collecting and pre-processing the sensor data, determines the user's tendency, infers a redundancy function by using the inferred user's situation and the determined user's tendency, and adjusts the inferred redundancy function.

### PRIORITY

This application claims priority under 35 U.S.C. §119(a) to Korean Patent Application Serial No. 10-2014-0075111, which was filed in the Korean Intellectual Property Office on Jun. 19, 2014, the contents of which are incorporated herein by reference.

### BACKGROUND OF THE INVENTION

1. Field of the Invention

The present disclosure relates to an electronic apparatus and a method of managing functions in the electronic apparatus.

2. Description of the Related Art

The recent development of mobile communications systems and devices has allowed users to carry an electronic apparatus such as a smartphone, and to use various functions of the electronic apparatus anywhere at any time. However, as the electronic apparatus has become equipped with more functions, the amount of battery usage to perform each function has increased, thereby limiting the operable time of the electronic apparatus. Accordingly, without proper management of the functions used in the electronic apparatus, unnecessary power consumption occurs, thereby inconveniently and unnecessarily decreasing the operable time of the electronic apparatus.

To address this issue, studies for the management of various functions of the electronic apparatus have recently been performed. However, most studies have only focused on managing a Global Positioning System (GPS) function based on the location of the electronic apparatus, and not on managing various functions with a plurality of modules such as Bluetooth®, Wi-Fi, GPS, acceleration, and illumination.

Further, since the conventional management of electronic apparatus functions is primarily based on the usage pattern of the user of the electronic apparatus, there is a need in the art for a technique of managing functions by considering both the dynamically-changing user situation and the static user tendencies.

### SUMMARY OF THE INVENTION

The present disclosure has been made to address at least the above-mentioned problems and/or disadvantages and to provide at least the advantages described below. Accordingly, an aspect of the present disclosure is to provide an electronic apparatus and a method of managing the functions in the electronic apparatus, by combining heterogeneous information such as the user's situation and the user's tendency.

Another aspect of the present disclosure is to provide an electronic apparatus and a method of managing the functions in the electronic apparatus, which can manage various functions respectively with a plurality of modules such as Bluetooth, Wi-Fi, GPS, acceleration, illumination, etc., considering both of the user's situation and the user's tendency.

According to an aspect of the present invention, an electronic apparatus includes a sensor unit that includes at least one sensor and outputs sensor data by each of the at least one sensor, and a controller that infers a user's situation by collecting and pre-processing the sensor data, determines a user's tendency, infers a redundancy function by using the inferred user's situation and the determined user's tendency, and adjusts the inferred redundancy function.

According to an aspect of the present invention, a method of managing a function in an electronic apparatus includes detecting sensor data by each of at least one sensor through the at least one sensor, inferring a user's situation by collecting and pre-processing the sensor data and determining a user's tendency, inferring a redundancy function by using the inferred user's situation and the determined user's tendency, and adjusting the inferred redundancy function.

According to an aspect of the present invention, a non-transitory computer-readable recording medium for storing a program for executing a process in an electronic apparatus is provided, wherein the process includes detecting sensor data by each of at least one sensor through the at least one sensor, inferring a user's situation by collecting and pre-processing the sensor data and determining a user's tendency, inferring a redundancy function by using the inferred user's situation and the determined user's tendency, and adjusting the inferred redundancy function.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram of an electronic apparatus according to an embodiment of the present invention;

FIG. 2 is a block diagram of a controller according to an embodiment of the present invention;

FIG. 3 is a table illustrating sensor data according to an embodiment of the present invention;

FIG. 4 is a table illustrating a pre-processing result according to an embodiment of the present invention;

FIG. 5 is a table illustrating a user's tendency according to an embodiment of the present invention;

FIGS. 6A and 6B are tables illustrating a determination of a user's tendency according to an embodiment of the present invention;

FIG. 7 is a conceptual diagram illustrating a redundancy function inference unit according to an embodiment of the present invention;

FIG. 8 is a table illustrating a function adjustment according to an embodiment of the present invention;

FIG. 9 is a flowchart illustrating a function management operation in an electronic apparatus according to an embodiment of the present invention;

FIG. 10 is a diagram illustrating a forgetting function graph according to an embodiment of the present invention; and

FIGS. 11A and 11B are diagrams illustrating screens corresponding to a function management operation in an electronic apparatus according to an embodiment of the present invention.

### DETAILED DESCRIPTION OF EMBODIMENTS OF THE INVENTION

Embodiments of the present disclosure will be described with reference to the accompanying drawings. The present disclosure may have various modifications and embodiments and thus will be described in detail with reference to specific embodiments illustrated in the drawings. However, it should be understood that the present disclosure is not limited thereto, and should be construed to cover all modifications, equivalents, and/or alternatives falling within the spirit and scope of the disclosure. In the description of the drawings, identical or similar reference numerals are used to designate identical or similar elements. Descriptions of well-known functions and constructions may be omitted for the sake of clarity and conciseness.

In the present invention, the expressions “include” or “may include” refers to existence of a corresponding function, operation, or element, and is not limited to one or more additional functions, operations, or elements. Further, the terms “include”, “have” and their conjugates may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all combinations of listed words. For example, the expression “A or B” includes A, or includes B.

In the present invention, expressions including ordinal numbers, such as “first” and ‘second,’ etc., may modify various elements. However, such elements are not limited by the above expressions. For example, the above expressions do not limit the sequence and/or importance of the elements, but are used merely for the purpose of distinguishing an element from the other elements. For example, a first user device and a second user device indicate different user devices, although both are user devices. Also, without departing from the scope of the present disclosure, a first component element may be referred to as a second component element. Similarly, the second component element may be referred to as the first component element.

When an element is referred to as being “coupled” or “connected” to any other element, it should be understood that the element may be directly coupled or connected to the other element, and a third element may be interposed therebetween. In contrast, when an element is referred to as being “directly coupled” or “directly connected” to any other element, it should be understood that no element is interposed therebetween.

The terms used to describe various embodiments of the present disclosure are used to describe a specific embodiment, and are not intended to limit the present disclosure. As used herein, the singular forms are intended to include the plural forms as well, unless the context clearly indicates otherwise.

Unless defined otherwise, all terms used herein, including technical and scientific terms, have the same meaning as commonly understood by those skilled in the art to which the present disclosure pertains. Such terms as those defined in a generally used dictionary are to be interpreted to have the same meanings as the contextual meanings in the relevant field of art, and are not to be interpreted to have ideal or excessively formal meanings unless clearly defined in the present disclosure.

For example, the electronic device includes at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MPEG-Layer Audio 3 (MP3) player, a mobile medical device, a camera, and a wearable device (for example, a Head-Mounted-Device (HMD) such as electronic glasses, electronic clothes, an electronic bracelet, an electronic necklace, an electronic accessory, an electronic tattoo, and a smart watch).

According to some embodiments, the electronic device may be a smart home appliance such as a television, a Digital Video Disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic picture frame.

According to some embodiments, the electronic device includes at least one of various types of medical devices (for example, Magnetic Resonance Angiography (MRA), Magnetic Resonance Imaging (MRI), Computed Tomography (CT), a scanning machine, and ultrasonic wave device), a navigation device, a GPS receiver, an Event Data Recorder (EDR), a Flight Data Recorder (FDR), a car infotainment device, ship electronic equipment (for example, navigation equipment for a ship, and a gyro compass), avionics, a security device, and an industrial or home robot.

According to some embodiments, the electronic device includes at least one of a part of furniture or a building/structure, an electronic board, an electronic signature receiving device, a projector, and various types of measuring instruments (e.g., a water meter, an electric meter, a gas meter, and a radio wave meter). An electronic device according to various embodiments of the present disclosure may be a combination of one or more of above described various devices, and the present disclosure is not limited to the above described devices.

According to the present invention, since unnecessary functions as will be described can be managed in the electronic apparatus by considering both of the dynamically-changing user's situation in the electronic apparatus and the user's static tendencies, a more efficient management of the functions and longer use of the battery are provided.

Further, according to various embodiments of the present invention, since various functions can be managed respectively with various modules such as Bluetooth®, Wi-Fi, GPS, acceleration, and illumination modules by considering both of the user's situation and tendencies, improved management of the functions is also provided.

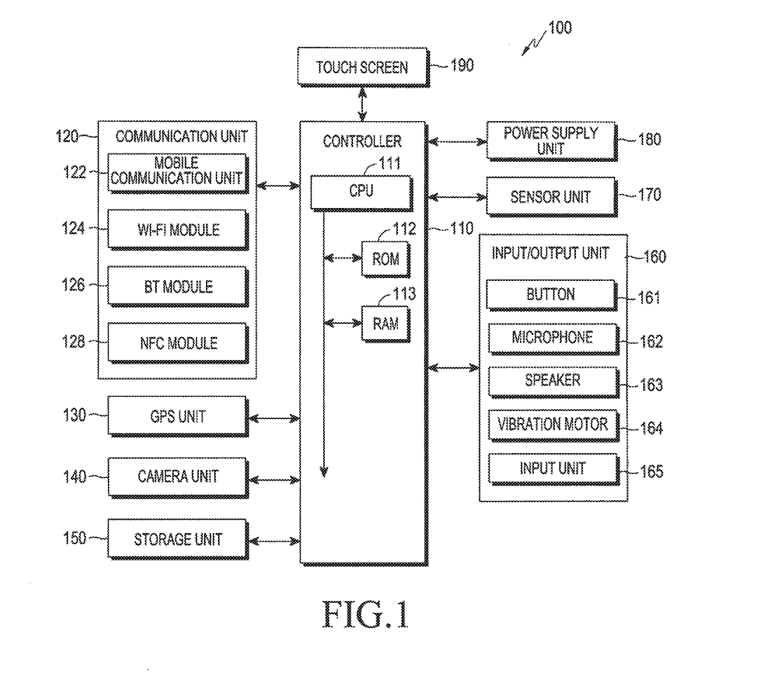

FIG. 1 is a block diagram of an electronic apparatus according to an embodiment of the present invention. Referring to FIG. 1, the electronic apparatus 100 includes a controller 110, a communication unit 120, a GPS unit 130, a camera unit 140, a storage unit 150, an input/output unit 160, a sensor unit 170, a power supply unit 180, and a touch screen 190.

The controller 110 includes a CPU 111, a ROM 112 storing a control program for controlling the electronic apparatus 100, and a RAM 113 for storing a signal or data input from external to the electronic apparatus 100 or for work performed in the electronic apparatus 100. The CPU 111 includes a single core, a dual core, a triple core, or a quad core, for example. The CPU 111, the ROM 112 and the RAM 113 may be connected with each other through internal buses. The controller 110 controls the communication unit 120, the GPS unit 130, the camera unit 140, the storage unit 150, the input/output unit 160, the sensor unit 170, the power supply unit 180, and the touch screen 190. In accordance with an embodiment, the controller 110 infers the user's situation by collecting and preprocessing the sensor data, determine the user's tendency, infer a redundancy function by using the inferred result of the user's situation and the determined result of the user's tendency, and adjust the inferred redundancy function.

The communication unit 120 enables the electronic apparatus 100 to communicate with an external device based on the control of the controller 110 by using at least one antenna through at least one communication module. The communication unit 120 includes a mobile communication module 122, a Wi-Fi module 124, Bluetooth® (BT) module 126, and a Near Field Communication Module (NFC) 128. The mobile communication module 122 transmits and receives a wireless signal for voice communication, image communication, text message (SMS), or multimedia message (MMS) to/from a portable phone of which the phone number is input to the electronic apparatus 100, a smart phone , a tablet PC, or other apparatuses.

The Wi-Fi module 124 may be connected to the Internet in a location where a wireless Access Point (AP) is installed, based on the control of the controller 110. The wireless LAN module 124 supports a wireless LAN standard (IEEE802.11x) of the Institute of Electrical and Electronics Engineers (IEEE). The BT module 126 wirelessly performs BT communication between the electronic apparatus 100 and an image-forming device based on the control of the controller 110. The NFC module 128 performs NFC communication between the electronic apparatus 100 and an external device based on the control of the controller 110. The communication module 120, in addition to the communication modules, may further include other communication modules such as an Infrared Data Association (IrDA) module and a WiFi-Direct communication module.

The GPS module 130 receives radio waves from a plurality of GPS satellites in the Earth's orbit and calculates a position of the electronic apparatus 100 by using Time of Arrival from the GPS satellites to the electronic apparatus 100.

The camera unit 140 includes a camera for capturing still images or videos based on the control of the controller 110. In addition, the camera unit 140 performs zoom in/zoom out in order to photograph a subject and also provides an auxiliary light source needed to photograph the subject.

The storage unit 150, based on the control of the controller 110, stores a signal or data inputting/outputting corresponding to the operations of the camera unit 140, the GPS unit 130, the input/output unit 160, the sensor unit 170, the power supply unit 180, and the touch screen 190. The storage unit 150 stores a plurality of programs and applications for control of the electronic apparatus 100 or the controller 110.

The term “storage unit” includes the storage unit 150, the ROM 112 and the RAM 113 within the controller 110, or a memory card such as a Secure Digital (SD) card or a memory stick installed in the electronic apparatus 100. The storage unit includes a nonvolatile memory, a volatile memory, a Hard Disk Drive (HDD), or a Solid State Drive (SSD).

The storage unit 150 stores applications with various applications such as navigation, video call, game, and user alarm , as well as images for providing a Graphical User Interface (GUI) relating to the applications, databases or data relating to a method of processing user information, a document and a touch input, background images (i.e. a menu screen or a standby screen), or operation programs necessary for an operation of the electronic apparatus 100, still images and video taken by the camera module. The storage unit 150 is a machine (for example, computer)-readable medium, and the term “machine-readable medium” may be defined as a medium capable of providing data to the machine so that the machine performs a specific function. The machine-readable medium may be storage medium. The storage unit 150 includes a non-volatile memory and a volatile memory. The foregoing media allows commands transferred by the media to be detected by a physical mechanism through which the machine reads the commands.

The machine readable medium includes at least one of a floppy disk, a flexible disk, a hard disk, a magnetic tape, a Compact Disc Read-Only Memory (CD-ROM), an optical disk, a punch card, a paper tape, a RAM, a Programmable Read-Only Memory (PROM), an Erasable PROM (EPROM), and a Flash-EPROM, without being limited thereto.

The input/output unit 160 includes at least one of a plurality of buttons 161, a microphone 162, a speaker 163, a vibration motor 164, and an input unit 165. The input/output unit 160 is not limited thereto, and may be provided for a cursor control such as a mouse, a trackball, a joystick or cursor direction keys to control the communication with the controller 110 and to control the movement of the cursor on the touch screen 190.

The button 161 may be formed on a front, side, or rear surface of a housing of the electronic apparatus 100, and includes at least one of a power/lock button, a volume button, a menu button, a home button, a back button, and a search button.

The microphone 162 generates an electric signal by receiving voice or various sounds based on the control of the controller 110.

The speaker 163 outputs the sound corresponding to various sound signals such as radio and broadcast signals, digital audio and/or video files, and photography, by a plurality of components such as the communication unit 120 and the camera unit 140 to external to the electronic apparatus 100, based on the control of the controller 110. One or more speakers 163 may be formed on a suitable position or positions of the housing of the electronic apparatus 100.

The vibration motor 164 converts an electrical signal to a mechanical vibration based on the control of the controller 110. For example, if the voice call from another device is received, the electronic apparatus 100 in the vibration mode is capable of operating the vibration motor 164, and one or multiple vibration motors can be formed within the housing of the electronic apparatus 100. The vibration motor 164 may operate in response to a touch action of the user made on the touch screen 190 or successive movements of the touch on the touch screen 190.

The input unit 165 may be inserted into the electronic apparatus 100 to be stored in the electronic apparatus 100, and withdrawn and detached from the electronic apparatus 100 when being used. An attachment/detachment switch that operates in response to the mounting and demounting of the input unit 165 is provided at the location within the electronic apparatus 100 where the input unit 165 is inserted, and may provide a signal corresponding to the mounting and demounting of the input unit 165 to the controller 110. The attachment/detachment switch is provided at the location where the input unit 165 is inserted, in a manner that directly or indirectly contacts the input unit 165 when the input unit 165 is mounted on the location. Accordingly, the attachment/detachment recognition switch generates a signal corresponding to the attachment or detachment of the input unit 165 based on the direct or indirect contact with the input unit 165, and then provides the generated signal to the controller 110.

The sensor unit 170 includes at least one sensor for detecting the status of the electronic apparatus 100. For example, the sensor unit 170 may include a proximity sensor for detecting whether the user access to the electronic apparatus 100, an illuminance sensor for detecting the amount of the light around the electronic apparatus 100, an acceleration sensor for detecting the operation of the electronic apparatus 100 (for example, the rotation of the electronic apparatus 100, an acceleration or a vibration applied to the electronic apparatus 100), a geo-magnetic sensor for detecting a point of the compass by utilizing geomagnetic field, a gyro sensor for detecting an angular velocity of the electronic apparatus 100, a temperature sensor for detecting ambient temperature, a humidity sensor for detecting humidity, a time sensor that detects time, a battery sensor for detecting remaining battery power, and a direction sensor for detecting the inclination of each direction of the electronic apparatus 100. The sensor unit 170 may further include other sensors such as a gravity sensor that detects the direction of gravity, and an altimeter that detects height by measuring the pressure of the atmosphere. At least one of the sensors can detect a state of a user or electronic apparatus 100, generate a signal corresponding to the detection, and transmit the generated signal to the controller 110. The sensor of the sensor unit 170 may be added or omitted according to the performance of the electronic apparatus 100.

The power supply unit 180 supplies electrical power to one or more batteries disposed in the housing of the electronic apparatus 100 under the control of the controller 110. The one or multiple batteries supply power to the electronic apparatus 100. The power supply unit 180 supplies electric power which is input from the external power source to the electronic apparatus 100 through a wired cable which is linked to the connector, and supplies electric power, which is wirelessly input from the external electric power source through a wireless charging technology, to the electronic apparatus 100.

The electronic apparatus 100 further includes at least one touch screen 190 that provides a user interface corresponding to the various functions (for example, a call function, a data transmission function, a photographing function, and function management) to the user. Hereinafter, description will be made on one touch screen for the convenience of explanation.

The touch screen 190 receives at least one user gesture through the user's body (for example, a finger including the index finger) or a touchable input unit 165 (for example, a stylus pen, and an electronic pen). The touch screen 190 includes a pen recognition panel that recognizes whether the input is made through the pen such as the stylus pen or the electronic pen, and this type of pen recognition panel determines a distance between the pen and the touch screen 190 via a magnetic field. The touch screen 190 receives a continuous movement of at least one touch as the user gesture, and transmits an analog signal corresponding to the incoming user gesture. A resistive, capacitive, infrared, or acoustic wave type of touch screen 190 may be implemented.

More particularly, the touch screen 190 has a sequentially laminated structure of panels which are formed to be closely adhered to each other or are partially separated between a panel that senses input by a finger or an input unit 165 through a change of the induced electromotive force and a panel that senses a contact by the finger or the input unit 165 on the touch screen 190. The touch screen 190 includes a plurality of pixels through which an image is displayed. The touch screen 190 may use a Liquid Crystal Display (LCD), an Organic Light Emitting Diode (OLED), or a Light Emitting Diode (LED).

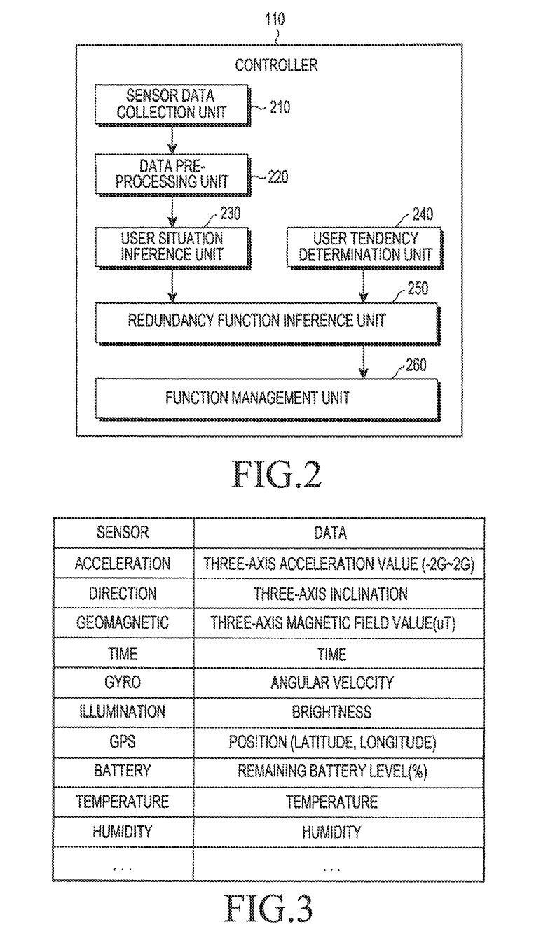

FIG. 2 is a block diagram illustrating a controller according to an embodiment of the present invention. Referring to FIG. 2, the controller 110 includes a sensor data collection unit 210, a data pre-processing unit 220, a user situation inference unit 230, user tendency determination unit 240, a redundancy function inference unit 250, and a function management unit 260.

The sensor data collection unit 210 collects various sensor data detected by the sensor unit 170. According to an embodiment, the sensor data collection unit 210 collects various sensor data detected from various sensors such as proximity, illuminance, acceleration, geomagnetic, gyro, temperature, humidity, time, battery, and direction sensors of the sensor unit 170.

The data pre-processing unit 220 preprocesses the collected sensor data. According to an embodiment, the data pre-processing unit 220 converts continuous sensor data into discrete sensor data, which is for reducing the amount of computation and memory usage. In order to pre-process the sensor data, any one among various artificial intelligence techniques such as a neural network, rule use technique such as Naive Bayes Classifier, and a decision tree technique can be utilized. According to an embodiment, the sensor data detected by the acceleration, direction, proximity, geomagnetic, and gyro sensors can be pre-processed by using the decision tree technique, and the sensor data detected by the time, illuminance, GPS, and battery sensors can be pre-processed with the rule use technique.

The user situation inference unit 230 infers the user's situation by receiving the pre-processed result data, and then applying a probability model to the pre-processed result data. According to various embodiments, the probability model may utilize a Dynamic Bayesian network, a Bayesian network, a Naive Bayes Classifier, a Hyper network, and a Tree-augmented Bayesian classifier. The user's situation includes the user's posture or motion, a frequency in use of the apparatus, a usability state of the apparatus, location of the apparatus, the user's location, and various states of the user such as a state of rest, sleeping, moving, being indoors or outdoors, viewing, shopping, exercising, dining, taking a class, and working. According to an embodiment, the user situation inference unit 230 adjusts the frequency of redundancy function inference by determining the frequency of occurrence of situation changes, and using a forgetting function corresponding to the frequency of occurrence of situation changes.

The user tendency determination unit 240 determines to which at least one tendency the user's tendency belongs out of predetermined propensities. According to an embodiment, the user tendency determination unit 240 determines to which tendency the user's tendency belongs out of the propensities such as Openness to experience, Conscientiousness, Extroversion, Agreeableness, and Neuroticism. According to the various embodiments of the present disclosure, the user's propensities can be predetermined by experimental statistics, and can be classified as other propensities than the above propensities. The redundancy functional inference unit 250 infers the redundancy function by using the user's situation inference result and the user's tendency determination result. According to an embodiment, the redundancy function may refers to a function which is not always required to be used in view of the user's situation and user's tendency and consumes unnecessary power. According to an embodiment, the redundancy functional inference unit 250 infers the redundancy function by using the predetermined probability model.

The function management unit 260 adjusts each function based on the redundancy function inference result. According to an embodiment, if the redundancy function is in the ON state, the function management unit 260 adjusts the redundancy function from the ON state to an OFF state. When a function other than the redundancy function is in the OFF state, the function other than the redundancy function can be adjusted from the OFF state to the ON state.

According to various embodiments of the present invention, when the user's situations are identical, the function can be adjusted depending on the user's tendency, and when the user's propensities are identical, the function can be adjusted depending on the user's situation, so that the function considering both of the user's situation and user's tendency can be adjusted. For example, a user with a tendency towards Conscientiousness is more likely to perform e-mail synchronization than a user with a tendency towards Extroversion, so that the synchronization function is adjustable according to the user's tendency.

FIG. 3 is a table illustrating sensor data according to an embodiment of the present invention. Referring to FIG. 3, the sensor data collection unit 210 collects a three-axis acceleration value from the acceleration sensor, a three-axis inclination value from the direction sensor, a three-axis geomagnetic value from the geomagnetic sensor, time value from a time sensor, an angular velocity value from the gyro sensor, a brightness value from the illumination sensor, a value of position (latitude, longitude) from the GPS sensor, the percentage of the remaining battery level from the battery sensor, temperature from a temperature sensor, and humidity from a humidity sensor.

The collected sensor data may be pre-processed by the data pre-processing unit 220.

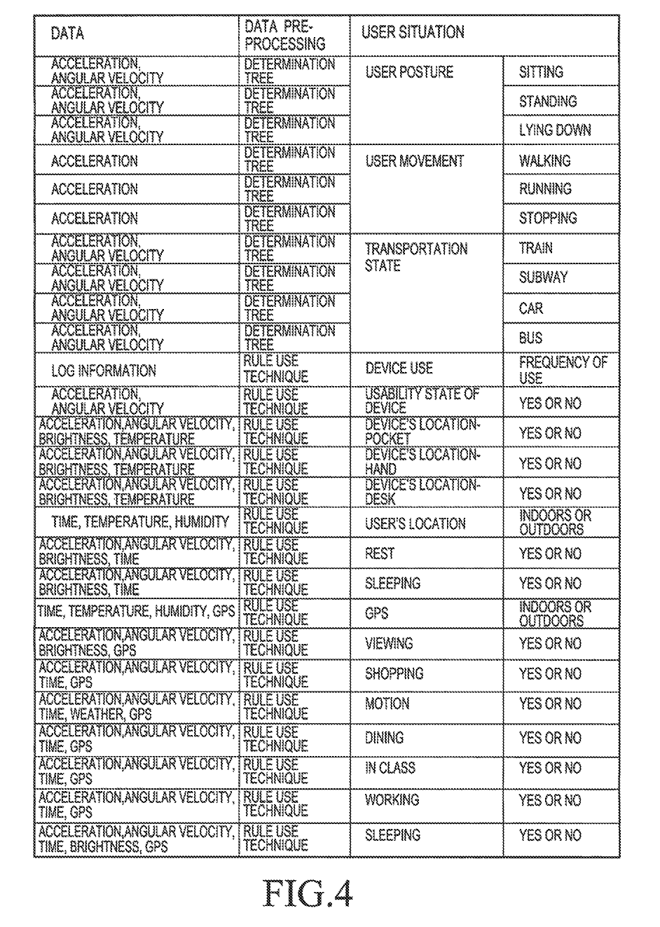

FIG. 4 is a table illustrating a pre-processing result according to an embodiment of the present invention.

Referring to FIG. 4, the data pre-processing unit 220 pre-processes the acceleration value and the angular velocity value with a decision tree technique, and then outputs the pre-processed result data indicating whether the user's posture is of sitting, standing, or lying down. The data pre-processing unit 220 pre-processes the acceleration values with the decision tree technique, and then outputs the pre-processed result data indicating whether the user's movement is walking, running, or stopped. The data pre-processing unit 220 pre-processes the acceleration value and the angular velocity value with the decision tree technique, and then outputs the pre-processed result data indicating whether the transportation means is a train, a subway, an automobile, or a bus. The data pre-processing unit 220 pre-processes the log information with the rule use technique, and then output the pre-processed result data indicating the frequency of the device usage. The data pre-processing unit 220 pre-processes the acceleration value and the angular velocity value with the rule use technique, and then outputs the pre-processed result data indicating whether the available state of the electronic apparatus 100 is YES or NO. The data pre-processing unit 220 pre-processes the acceleration value, the angular velocity value, the brightness value, and the temperature value with the rule use technique, and then outputs the pre-processed result data indicating whether the electronic apparatus 100 is (YES) or is not (NO) located in a pocket, such as a pants pocket of a user. The data pre-processing unit 220 pre-processes the acceleration value, the angular velocity value, the brightness value, and the temperature value with the rule use technique, and then outputs the pre-processed result data indicating whether the electronic apparatus 100 is (YES) or is not (NO) located in a user's hand. The data pre-processing unit 220 pre-processes the acceleration value, the angular velocity value, the brightness value, and temperature value with the rule use technique, and then outputs the pre-processed result data indicating whether the electronic apparatus 100 is (YES) or is not (NO) located on a desk. The data pre-processing unit 220 pre-processes the time value, the temperature value, and the humidity value with the rule use technique, and then outputs the pre-processed result data indicating whether the location of the user is indoors or outdoors. The data pre-processing unit 220 pre-processes the acceleration value, the angular velocity value, the brightness value, the time value with the rule use technique, and then output the pre-processed result data indicating whether the user is (YES) or is not (NO) at rest. The data pre-processing unit 220 pre-processes the acceleration value, the angular velocity value, the brightness value, and the time value with the rule use technique, and then outputs the pre-processed result data indicating whether the user is (YES) or is not (NO) sleeping.

The data pre-processing unit 220 pre-processes the time value, the temperature value, the humidity value, and the GPS value with the rule use technique, and then outputs the pre-processed result data indicating whether the GPS is located indoors or outdoors. The data pre-processing unit 220 pre-processes the acceleration value, the angular velocity value, the brightness value, and the GPS value with the rule use technique, and then outputs the pre-processed result data indicating whether the user is (YES) or is not (NO) viewing a show, a game, or a movie for example. The data pre-processing unit 220 pre-processes the acceleration value, the angular velocity value, the time value, and the GPS value with the rule use technique, and then outputs the pre-processed result data indicating whether the user is (YES) or is not (NO) shopping.

The data pre-processing unit 220 pre-processes the acceleration value, the angular velocity value, the time value, the weather value, and the GPS value with the rule use technique, and then outputs the pre-processed result data indicating whether the user is (YES) or is not (NO) in motion. The data pre-processing unit 220 pre-processes the acceleration value, the angular velocity value, the time value, and the GPS value with the rule use technique, and then outputs the pre-processed result data indicating whether the user is (YES) or is not (NO) dining. The data pre-processing unit 220 pre-processes the acceleration value, the angular velocity value, the time value, and the GPS value with the rule use technique, and then outputs the pre-processed result data indicating whether the user is (YES) or is not (NO) in class, such as a classroom setting. The data pre-processing unit 220 pre-processes the acceleration value, the angular velocity value, the time value, and the GPS value with the rule use technique, and then outputs the pre-processed result data indicating whether the user is (YES) or is not (NO) working. The data pre-processing unit 220 pre-processes the acceleration value, the angular velocity value, the time value, the brightness value, and the GPS value with the rule use technique, and then outputs the pre-processed result data indicating whether the user is (YES) or is not (NO) sleeping.

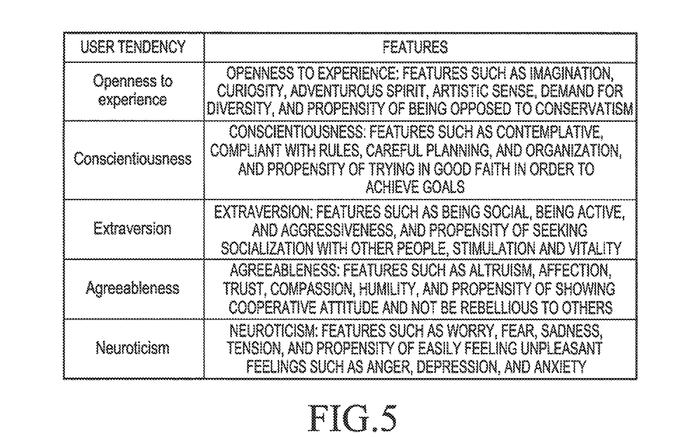

FIG. 5 is a table illustrating a user's tendency according to an embodiment of the present invention.

Referring to FIG. 5, a user with a tendency towards Openness to experiences has features such as imagination, curiosity, adventurous spirit, an artistic sense, and a demand for diversity, and may have a tendency for anti-conservatism. A user with a tendency towards Conscientiousness has features such as contemplative, compliant with rules, careful planning, and organization, and may have a tendency for purpose-oriented hard work. A user with a tendency towards Extroversion has features such as being social, active, and aggressive, and may have a tendency to seek socialization with other people, stimulation and vitality. A user with a tendency towards Agreeableness has features such as altruism, affection, trust, compassion, humility, and may have a tendency to show a cooperative attitude not be rebellious to others. A user with a tendency towards Neuroticism has features such as worry, fear, sadness, and tension, and may have a tendency towards unpleasant feelings such as anger, depression, and anxiety.

According to various embodiments of the present invention, the user's propensities can be predetermined by experimental statistics, for example, and can be classified into other propensities, in addition to the above propensities.

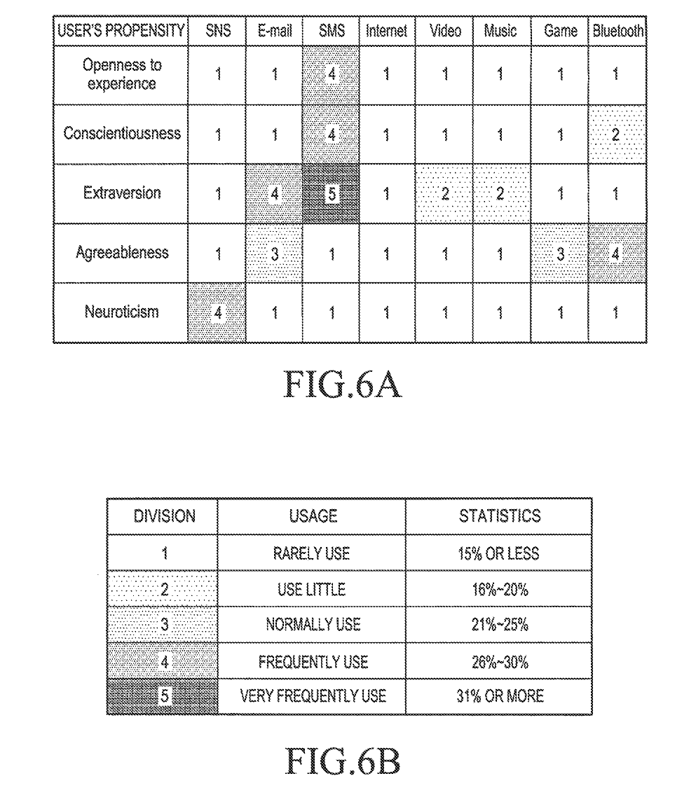

FIGS. 6A and 6B are tables illustrating a determination of a user's tendency according to an embodiment of the present invention. Referring to FIGS. 6A and 6B, the user tendency determination unit 240 determines the user's tendency by using statistics of an amount of use of any of the functions among the different functions (or applications), for example, SNS, e-mail, Internet, video, music, game, or Bluetooth® functions.

According to embodiments, the user tendency determination unit 240 determines that the user who relatively frequently uses the SMS function among various functions belongs to the Openness tendency, determines that the user who relatively frequently uses the SMS function and rarely uses the Bluetooth® function among various functions belongs to the Conscientiousness tendency, determines that the user who much more frequently uses the SMS function, somewhat frequently uses the e-mail function and seldomly uses video and music functions among various functions belongs to the Extroversion tendency, determines that the user who frequently uses the Bluetooth® function and normally uses the game function and e-mail among various functions belongs to the Agreeableness tendency, and determines that the user who relatively frequently uses the SNS function among various functions belongs to the Neuroticism tendency.

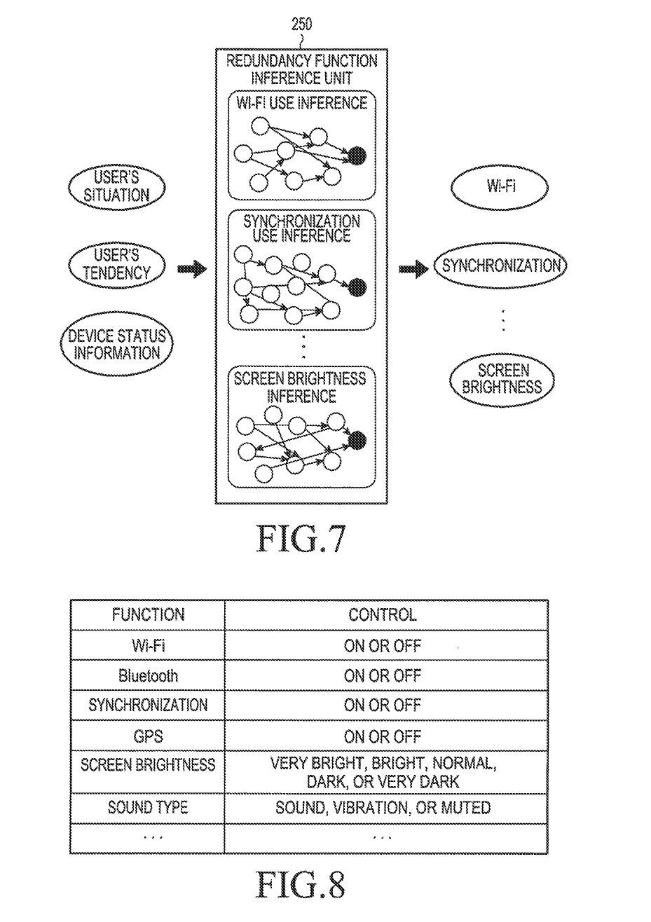

FIG. 7 is a conceptual diagram illustrating a redundancy function inference unit according to an embodiment of the present invention. Referring to FIG. 7, the redundancy function inference unit 250 receives the user's situation inference result and the user's tendency determination result, and infers the redundancy function using the predetermined probability model. According to an embodiment, the redundancy function inference unit 250 infers whether the current Wi-Fi in use is a necessary or unnecessary function by using the user's situation and the user's tendencyI, infers whether the current synchronization in use is a necessary or unnecessary function by using the user's situation and the user's tendency, and infers whether the current screen brightness adjustment is required by using the user's situation and the user's tendency.

The redundancy function inference unit 250 outputs the inferred result of the redundancy function. According to an embodiment, the redundancy function inference unit 250 outputs the signal of the inferred result from using the Wi-Fi function, the signal of the inferred result from using the synchronization function, or the signal of the inferred result from the brightness function of the screen, as a result of the redundancy function inference. In addition, the signals of the inferred result of a variety of redundancy functions can be output. In accordance with the inference result of the redundancy function, each of the function can be adjusted by the function management unit 260.

FIG. 8 is a table illustrating a function adjustment according to an embodiment of the present invention. Referring to FIG. 8, the function management unit 260, on the basis of the result of the redundancy function inference, controls the Wi-Fi, Bluetooth®, synchronization and GPS functions to be turned on or turned off, respectively, controls the brightness of the screen to be any one of very bright, bright, normal, dark, or very dark, and controls the sound type to be any one of a sound, a vibration, or to be muted.

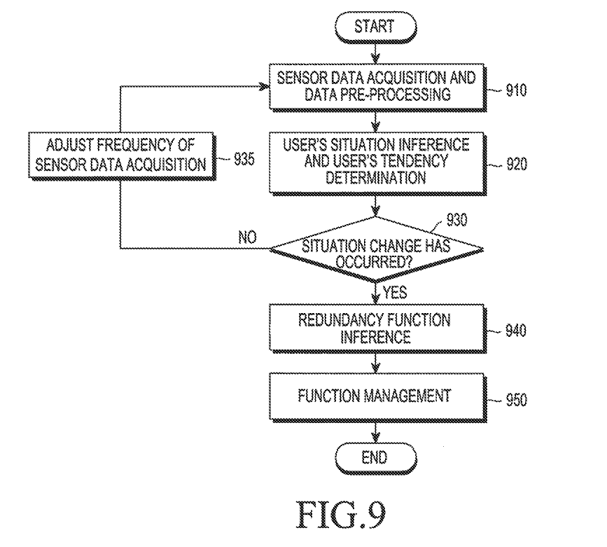

FIG. 9 is a flowchart illustrating a function management operation in an electronic apparatus according to an embodiment of the present invention. Referring to FIG. 9, the electronic apparatus 100, in step 910, obtains sensor data and perform pre-processing of the data.

According to an embodiment, the electronic apparatus 100 collects various sensor data detected from one or more sensors of the sensor unit 170, such as the proximity, illuminance, acceleration, geomagnetic, gyro, temperature, humidity, time, battery, and direction sensors. The electronic apparatus 100 pre-processes the collected sensor data. According to an embodiment, the electronic apparatus 100 converts the sensor data from continuous data into discrete data through the data pre-processing unit 220. The discrete data may be for reducing the amount of computation and memory usage. In order to pre-process the sensor data, any one among various artificial intelligence techniques such as a neural network, a rule use technique such as a naive Bayes classifier, and a decision tree technique can be utilized. According to an embodiment, the sensor data detected by the acceleration, direction, proximity, geomagnetic, and gyro sensors can be pre-processed using the decision tree technique, and the sensor data detected by the time, illuminance, GPS, and battery sensors can be pre-processed with the rule use technique.

The electronic apparatus 100 infers the user's situation and determines the user's tendency using the pre-processed result in step 920. The user situation inference unit 230 infers the user's situation by receiving the pre-processed result data through the user situation inference unit 230, and applying the probability model to the pre-processed result data. According to various embodiments, the probability model may utilize a Dynamic Bayesian network, a Bayesian network, a Naive Bayes Classifier, a Hyper network, a Tree-augmented Bayesian classifier. According to various embodiments, the user's situation includes a user's posture, a user's motion, a state of moving, a frequency in use of the device, a usability state of the device, location of the apparatus, a user's location, a states of rest, sleeping, being indoors or outdoors, viewing a show, a game, or a movie, shopping, exercising, dining, taking a class, and working. According to an embodiment of the present invention, the electronic apparatus 100, through the user tendency determination unit 240, determines to which at least one tendency among the predetermined propensities the user's tendency belongs. According to one embodiment, the user tendency determination unit 240 determines to which tendency the user's tendency belongs among the propensities such as Openness to experience, Conscientiousness, Extroversion, Agreeableness, and Neuroticism. The user's propensities can be predetermined by experimental statistics, for example, and can be classified into other propensities than the above propensities.

The electronic apparatus 100, in step 930, determines whether there is any situation change. If there is no change in situation, the electronic apparatus 100 adjusts the frequency of the sensor data acquisition in step 935, such as by using the forgetting function, and returns to step 910. For instance, the forgetting function may indicate the probability that a memory can be maintained as normal over time. The steeper the slope of the forgetting function gets, the lower the probability becomes that the memory can be maintained over time. Similar to the characteristics of such forgetting functions, since the probability may decrease over time that the sensor data is also maintained with the same values, the forgetting function can be utilized for sensor data acquisition frequency adjustment.

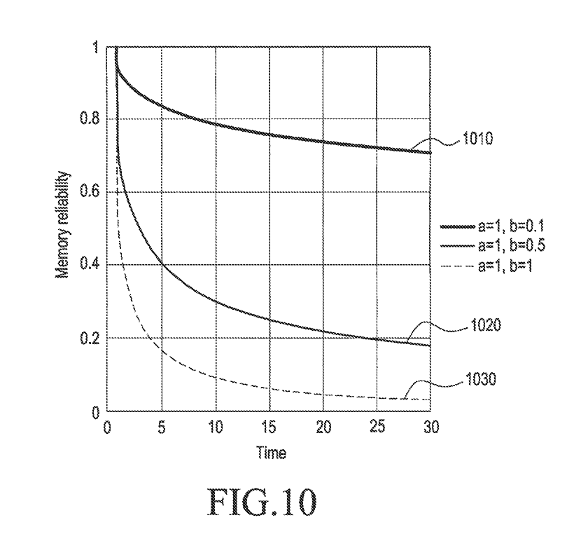

FIG. 10 is an example of a graph of the forgetting function according to an embodiment of the present invention. Referring to FIG. 10, any one forgetting function of the forgetting functions with different slopes can be utilized. According to an embodiment, any one of the forgetting functions of a first forgetting function 1010, a second forgetting function 1020, and a third forgetting function 1030 can be utilized. In the following order of the third forgetting function 1030, the second forgetting function 1020 and the first forgetting function 1010, the probability that the sensor data may be maintained over time decreases.

The electronic apparatus 100 may use any of these forgetting functions, if there is no change in situation, based on the probability of corresponding time, adjust the frequency of the sensor data acquisition, and then return to step 910. If no situation changes upon use of any of these forgetting functions, the electronic apparatus 100 adjusts the frequency of the sensor data acquisition based on the probability of corresponding time and returns to step 910.

Referring back to FIG. 9, the electronic apparatus 100 performs inferring of the redundancy function in step 940 when there is a change in situation. According to an embodiment, the electronic apparatus 100 infers the redundancy function using the user's situation inference result and the user's tendency determination result. The redundancy function may refer to a function which is not always required to be used in view of the user's situation and user's tendency and consumes unnecessary power.

According to an embodiment, the redundancy functional inference unit 250 infers the redundancy function by using the predetermined probability model.

The electronic apparatus 100, depending on the result of the redundancy function inference, performs the function adjustment in step 950. According to an embodiment, if the redundancy function through the function management unit 260 is in the ON state, the electronic apparatus 100 adjusts the redundancy function from the ON state to an OFF state, and if a function other than the redundancy function is in the OFF state, the electronic apparatus 100 adjusts the function other than the redundancy function from the OFF state to the ON state.

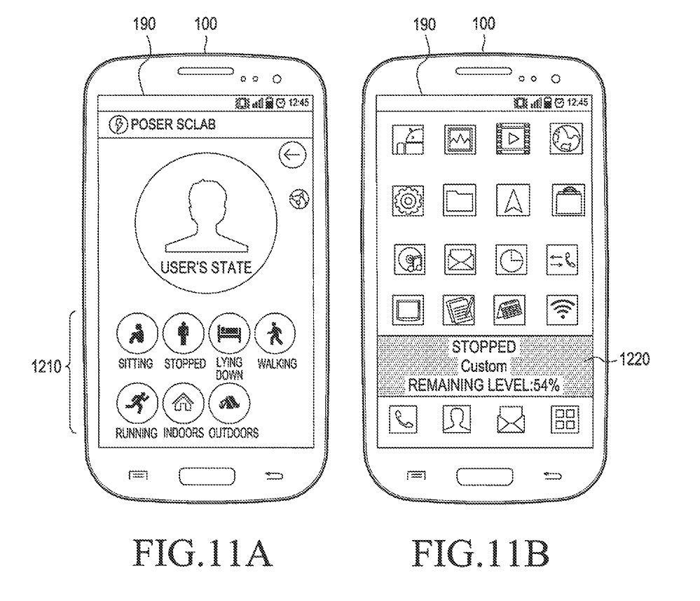

FIGS. 11A and 11B are diagrams illustrating screens corresponding to a function management operation in an electronic apparatus according to an embodiment of the present invention. Referring to FIG. 11A, the electronic apparatus 100 displays the user's situation inference result on the touch screen 190. The user's situation can be any one of sitting, stopped, lying down, walking, running, indoors, or outdoors, and a relevant situation can be highlighted. The electronic apparatus 100, as shown in FIG. 11 B, adjusts the function by considering both the user's situation and the user's tendency, and displays the information 1220 indicating the state of adjusting the function on the touch screen 190. According to an embodiment, information 1220 indicating the state of the function adjustment may indicate that the user's situation is stopped and in a custom state, and includes the information indicating that the remaining battery power is 54%.

The aforementioned elements of the electronic device according to various embodiments of the present disclosure may be constituted by one or more components, and the name of the corresponding element may vary with a type of electronic device. The electronic device according to various embodiments of the present disclosure includes at least one of the aforementioned elements. Some elements may be omitted or other additional elements may be further included in the electronic device. Some of the components of the electronic device according to the various embodiments of the present disclosure may be combined to form a single entity, and thus, may equivalently execute functions of the corresponding elements prior to the combination.

The “module” used in various embodiments of the present disclosure may refer to, for example, a “unit” including one of hardware, software, and firmware, or a combination of two or more of the hardware, software, and firmware. The “module” may be interchangeable with a term, such as a unit, a logic, a logical block, a component, or a circuit. The “module” may be a minimum unit of an integrated component element or a part thereof. The “module” may be a minimum unit for performing one or more functions or a part thereof. The “module” may be mechanically or electronically implemented. For example, the “module” according to various embodiments of the present disclosure includes at least one of an Application-Specific Integrated Circuit (ASIC) chip, a Field-Programmable Gate Arrays (FPGAs), and a programmable-logic device for performing operations which have been known or are to be developed hereafter.

According to various embodiments, at least a part of a device (for example, modules or functions thereof) or a method (for example, operations) according to the various embodiments of the present disclosure may be embodied by, for example, a command stored in a computer readable storage medium in a form of a programming module. When the command is executed by one or more processors (for example, the processor 110), the one or more processors may execute a function corresponding to the command. The computer-readable storage medium may be, for example, the memory 150. At least some of the programming modules may be implemented (for example, executed) by, for example, the processor 120. At least a part of the programming module may, for example, include a module, a program, a routine, a set of instructions, or a process for performing at least one function.

The computer readable recording medium includes magnetic media such as a hard disc, a floppy disc, and a magnetic tape, optical media such as a Compact Disc Read Only Memory (CD-ROM) and a Digital Versatile Disc (DVD), magneto-optical media such as a floptical disk, and hardware devices specifically configured to store and execute program commands, such as a Read Only Memory (ROM), a Random Access Memory (RAM), and a flash memory. In addition, the program instructions may include high class language codes, which can be executed in a computer by using an interpreter, as well as machine codes made by a compiler. The aforementioned hardware device may be configured to operate as one or more software modules in order to perform the operation of various embodiments of the present invention, and vice versa.

A programming module according to the present disclosure may include at least one of the described component elements, a few of the component elements may be omitted, or additional component elements may be included. Operations executed by a module, a programming module, or other component elements according to various embodiments of the present disclosure may be executed sequentially, in parallel, repeatedly, or in a heuristic manner. Further, some operations may be executed in a different order, some of the operations may be omitted, or other operations may be added.

Although specific embodiments are described in the above description of the present invention, various modifications can be made without departing from the scope of the present invention. Accordingly, the scope of the present disclosure shall not be determined by the above-described embodiments, and is to be determined by the following claims and their equivalents.

What is claimed is:

1. An electronic apparatus comprising:
a sensor unit that includes at least one sensor and outputs sensor data by each of the at least one sensor; and
a controller that infers a user's situation by collecting and pre-processing the sensor data, determines a user's tendency, infers a redundancy function by using the inferred user's situation and the determined user's tendency, and adjusts the inferred redundancy function.

2. The apparatus of claim 1, wherein the controller comprises:
a sensor data collection unit that collects sensor data by each of the at least one sensor;
a data pre-processing unit that converts the collected data from continuous data to discrete data, pre-processes the collected data using a predetermined artificial intelligence technique, and outputs the pre-processed data;
a user situation inference unit that infers the user's situation by applying a predetermined probability model to the pre-processed data;
a user tendency determination unit that determines to which tendency among predetermined user's propensities the user's tendency belongs by using statistics of use of the electronic apparatus by the user;
a redundancy function inference unit that infers the redundancy function by using the inferred user's situation and the determined user's tendency; and
a function adjustment unit that adjusts the function according to the inferred redundancy function.

3. The apparatus of claim 1, wherein the sensor data comprises at least one of a three-axis acceleration value obtained by an acceleration sensor, a three-axis inclination value obtained by a direction sensor, a three-axis geomagnetic value obtained by a geomagnetic sensor, time value obtained by a time sensor, an angular velocity value obtained by a gyro sensor, a brightness value obtained by an illumination sensor, a value of position of latitude or longitude obtained by a Global Positioning System (GPS) sensor, a percentage of a remaining battery level obtained by a battery sensor, a temperature value obtained by a temperature sensor, and a humidity value obtained by a humidity sensor.

4. The apparatus of claim 1, wherein the user's situation comprises at least one of a user's posture, a user's motion, a state of motion, a frequency in use of the electronic apparatus, a usability state of the electronic apparatus, a location of the electronic apparatus, the user's location, a state of rest of the user, a state of sleeping of the user, a state of being indoors or outdoors of the user, a state of viewing a show by the user, a state of shopping by the user, a state of dining by the user, a state of taking a class by the user, and a state of working by the user.

5. The apparatus of claim 1, wherein the user's tendency comprises at least one of a tendency towards Openness to experience, Conscientiousness, Extroversion, Agreeableness, and Neuroticism.

6. The apparatus of claim 2, the artificial intelligence technique comprises at least one of a rule use technique and a decision tree technique.

7. The apparatus of claim 2, wherein the probability model comprises at least one of a Dynamic Bayesian network, a Bayesian network, a Naive Bayes Classifier, a Hyper network, and a Tree-augmented Bayesian classifier.

8. A method of managing a function in an electronic apparatus, comprising:
detecting sensor data by each of at least one sensor through the at least one sensor;
inferring a user's situation by collecting and pre-processing the sensor data and determining a user's tendency;
inferring a redundancy function by using the inferred user's situation and the determined user's tendency; and
adjusting the inferred redundancy function.

9. The method of claim 8, further comprising:
determining whether a situation change has occurred, based on the inferred user's situation; and
when there is no situation change, adjusting a frequency of acquisition of the sensor data.

10. The method of claim 8, wherein pre-processing the sensor data comprises:
converting the sensor data from continuous data to discrete data; and
pre-processing the converted data by using a predetermined artificial intelligence technique and outputting the pre-processed data.

11. The method of claim 8, wherein the user's situation is inferred by applying a predetermined probability model to the pre-processed data.

12. The method of claim 8, wherein determining the user's tendency comprises determining to which tendency among the predetermined user's propensities the user's tendency belongs by using statistics of use of the electronic apparatus by the user.

13. The method of claim 8, wherein the sensor data comprises at least one of a three-axis acceleration value obtained by an acceleration sensor, a three-axis inclination value obtained by a direction sensor, a three-axis geomagnetic value obtained by the geomagnetic sensor, time value obtained by a time sensor, an angular velocity value obtained by a gyro sensor, a brightness value obtained by an illumination sensor, a value of position of latitude or longitude obtained by a Global Positioning System (GPS) sensor, a remaining battery level obtained by a battery sensor, a temperature value obtained by a temperature sensor, and a humidity value obtained by a humidity sensor.

14. The apparatus of claim 8, wherein the user's situation comprises at least one of the user's posture, the user's motion, a state of motion, a frequency of use of the electronic apparatus, a usability state of the electronic apparatus, a location of the electronic apparatus, the user's location, a state of rest of the user, a state of sleeping of the user, a state of being indoors or outdoors of the user, a state of viewing a show by the user, a state of shopping by the user, a state of dining by the user, a state of taking a class by the user, and a state of working by the user.

15. The method of claim 8, wherein the user's tendency comprises at least one of a tendency towards Openness to experience, Conscientiousness, Extroversion, Agreeableness, and Neuroticism.

16. The method of claim 10, wherein the artificial intelligence technique comprises at least one of a rule use technique and a decision tree technique.

17. The method of claim 11, wherein the probability model comprises at least one of a Dynamic Bayesian network, a Bayesian network, a Naive Bayes Classifier, a Hyper network, a Tree-augmented Bayesian classifier.

18. A non-transitory computer-readable recording medium for storing a program for executing a process in an electronic apparatus,
wherein the process comprises:
detecting sensor data by each of at least one sensor through the at least one sensor;
inferring a user's situation by collecting and pre-processing the sensor data and determining a user's tendency;
inferring a redundancy function by using the inferred user's situation and the determined user's tendency; and
adjusting the inferred redundancy function.
